(19) United States
(12) Patent Application Publication
(10) Pub. No.: US 2015/0181917 A1
(43) Pub. Date: Jul. 2, 2015

(54) PLANT POWDER, PLANT BAG, AND DRIED PLANT; PLANT INCLUDING HERB, TEA, ROOT, FLOWER, FLOWER BUD, POLLEN, STEM, STEM SHOOT, LEAF, BULB, CEREAL GRAIN, NUT, SEED, BEAN, FRUIT, FRUIT SKIN, VEGETABLE, AND VEGETABLE SKIN

(71) Applicant: Alice Chang, South Pasadena, CA (US)

(72) Inventor: Alice Chang, South Pasadena, CA (US)

(21) Appl. No.: 14/091,046

(22) Filed: Jan. 2, 2014

(51) Int. Cl. A23L 1/30

(52) U.S. Cl. CPC A23L 1/3002

(57) ABSTRACT

Plant powder, plant bag, and dried plant are created with a wide range of various ingredients. Plant powder, plant bag, and dried plant are created comprising at least one plant ingredient, with at least one flavoring. At least one plant ingredient having nutrients including carbohydrates, vitamins, minerals, and antioxidants. At least one plant ingredient is in form selected from group consisting of plant powder, plant bag, and dried plant. At least one plant ingredient is selected from group consisting of herb, tea, root, flower, flower bud, pollen, stem, stem shoot, leaf, bulb, cereal grain, nut, seed, bean, fruit, fruit skin, vegetable, and vegetable skin. At least one plant ingredient can further comprising addition of at least one nutritional ingredient, and at least one food additive. At least one flavoring is selected from group consisting of bland, sweet, sour, bitter, salty, spicy, and pungent.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of comestibles, and more specifically relates to plant powder, plant bag, and dried plant; and plant including herb, tea, root, flower, flower bud, pollen, stem, stem shoot, leaf, bulb, cereal grain, nut, seed, bean, fruit, fruit skin, vegetable, and vegetable skin.

2. Description of the Related Art

Currently on the market, plant powder, plant bag, and dried plant are very limited in the ingredients.

Various attempts have been made to solve the above-mentioned problems such as those found in U.S. Patent and U.S. Publication Nos. U.S. Pat. No. 5,480,672 to Keigo Kusano et al; U.S. Pat. No. 6,086,933 to Erik I. Rockstrom; U.S. Pat. No. 4,135,003 to Franz Mohwinkel; U.S. Pat. No. 4,808,420 to John O. Springier et al; U.S. Publication No. 2010/0215826 to Gordon Douglas Campbell et al; U.S. Publication No. 2009/0130290 to Darryl Keith McCray; and U.S. Pat. No. 6,599,547 to Maria Dolores Martinez-Serna Villagran et al. This prior art is representative of comestibles relating to food. None of the above inventions and patents, taken either singly or in combination, is seen to describe the invention as claimed.

Ideally, plant powder, plant bag, and dried plant are created with a wide range of various ingredients and yet manufactured at a modest expense.

### BRIEF SUMMARY OF THE INVENTION

In view of the foregoing disadvantages inherent in the known related comestibles art, the present invention provides plant powder, plant bag, and dried plant created with a wide range of various ingredients.

Plant powder, plant bag, and dried plant are created comprising at least one plant ingredient, with at least one flavoring. At least one plant ingredient having nutrients including carbohydrates, vitamins, minerals, and antioxidants. At least one flavoring is selected from the group consisting of bland, sweet, sour, bitter, salty, spicy, and pungent.

The present invention holds significant improvements and serves as plant powder, plant bag, and dried plant made from various ingredients. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figure which accompany the written portion of this specification illustrate embodiments and method(s) of use for the present invention, plant powder, plant bag, and dried plant system, constructed and operative according to the teachings of the present invention.

FIG. 1 shows a perspective view illustrating a plant powder, plant bag, and dried plant system according to an embodiment of the present invention.

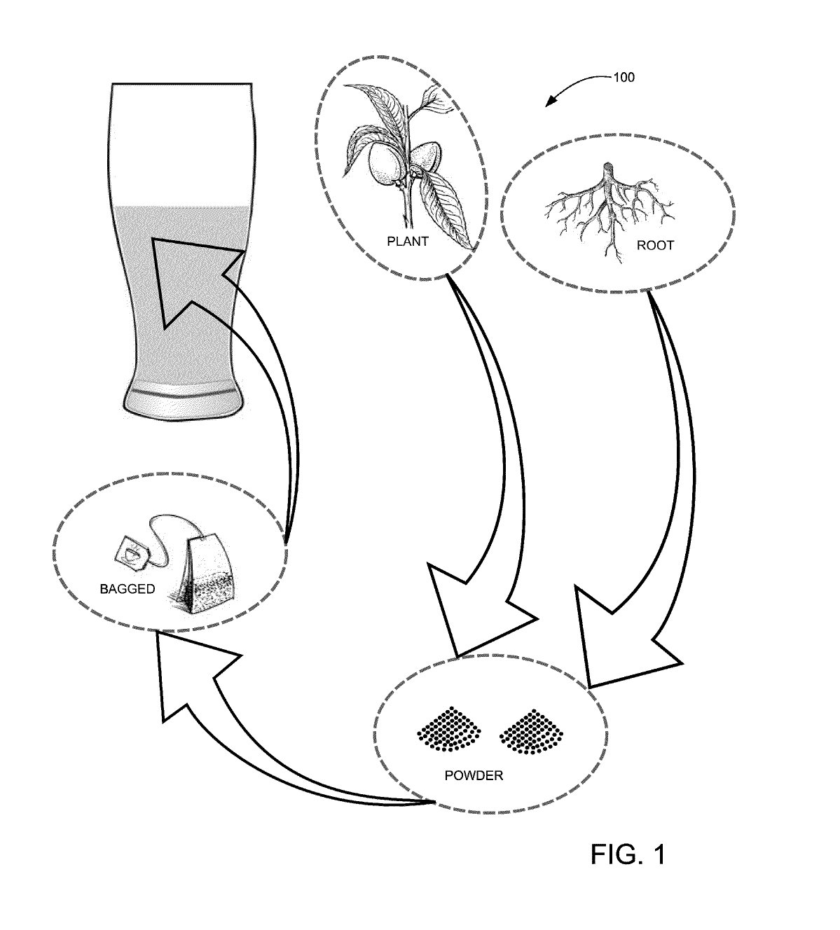

### DETAILED DESCRIPTION

As discussed above, embodiments of the present invention relate to a comestible and more particularly to plant powder, plant bag, and dried plant created with a wide range of various ingredients.

As mentioned earlier, plant powder, plant bag, and dried plant are created comprising at least one plant ingredient, with at least one flavoring. At least one plant ingredient having nutrients including carbohydrates, vitamins, minerals, and antioxidants. At least one flavoring is selected from the group consisting of bland, sweet, sour, bitter, salty, spicy, and pungent.

At least one plant ingredient is in form selected from the group consisting of plant powder, plant bag, and dried plant as plant powder, plant bag, and dried plant system designated as 100.

At least one plant ingredient is selected from the group consisting of herb, tea, root, flower, flower bud, pollen, stem, stem shoot, leaf, bulb, cereal grain, nut, seed, bean, fruit, fruit skin, vegetable, and vegetable skin.

At least one plant ingredient can further comprising addition of at least one nutritional ingredient selected from the group consisting of vitamin, dietary mineral, amino acid, and fatty acid. The vitamin includes vitamin A, vitamin B1, vitamin B2, vitamin B3, vitamin B5, vitamin B6, vitamin B7, vitamin B9, vitamin B12, vitamin C, vitamin D, vitamin E, and vitamin K. The dietary mineral includes calcium, phosphorus, potassium, sulfur, sodium, chlorine, magnesium, iron, cobalt, copper, zinc, molybdenum, iodine, selenium, manganese, nickle, chromium, fluorine, boron, and strontium. The amino acid includes histidine, isoleucine, leucine, lysine, methionine, cysteine, phenylalanine, tyrosine, threonine, tryptophan, and valine. The fatty acid includes alpha-linoleic acid, and linoleic acid.

At least one plant ingredient can further comprising addition of at least one food additive selected from the group consisting of acid, acidity regulator, alcohol, anticaking agent, antifoaming agent, antioxidant, bulking agent, coagulation agent, food coloring, color retention agent, emulsifier, flavor enhancer, flour treatment agent, gelling agent, glazing agent, humectant, leavening agent, tracer gas, preservative, stabilizer, sweetener, tenderizer, and thickener.

The plant powder is created by grinding of at least one plant ingredient into small particles.

The plant powder can be brewed in boiling water for about 5 to 30 minutes before consumption of resulting plant drink, which can be cooled with refrigeration.

The plant powder is created by method of boiling of at least one plant ingredient into plant drink; and by method selected from the group consisting of drying of said plant drink into soluble powder, freeze drying of said plant drink into granules, and spray drying of said plant drink into granules.

The plant powder can be dissolved in hot water for consumption of resulting plant drink, which can be cooled with refrigeration.

The plant powder is used as seasoning powder.

The plant powder can be enclosed in small bottle of sprinkler having small openings at top of sprinkler for convenience and ease of use seasoning food in suitable amounts.

The plant bag is created as porous bag containing plant powder. The porous bag having material selected from the group consisting of paper, cloth, rubber, and bio-plastic.

The plant bag can be brewed in boiling water for about 5 to 30 minutes before consumption of resulting plant drink, which can be cooled with refrigeration.

The dried plant is created by method selected from the group consisting of cut into thin slices, cut into small pieces, grind into small particles, and grind into powder; and by method selected from the group consisting of sun drying, drying by heat, deep frying, baking, steaming, boiling, roasting, grilling, and frying.

The dried plant comprising addition of at least one flavoring ingredient selected from the group consisting of salt, vinegar, sugar, honey, syrup, ginger, garlic, chocolate, coffee, tea, caramel, butterscotch, peanut butter, butter, margarine, cheese, cream cheese, cottage cheese, mozzarella, mascarpone, ricotta, cream, sour cream, milk, ice cream, yogurt, gelato, sherbet, vegetable shortening, fish oil, fish liver oil, plant wax, animal wax, beeswax, carnauba wax, royal jelly, glycerol, egg, seafood, meat, soup stock, lactase, yeast, propolis, quinine, malt, and at least one plant ingredient. At least one flavoring ingredient is in form selected from the group consisting of skin, skinned, unskinned, unshelled, cut, uncut, extract, juice, sauce, liquid, oil, gel, jelly, wax, cream, paste, powder, thin layer, small particles, and small pieces. At least one flavoring ingredient can be uncooked, and cooked by method selected from the group consisting of deep frying, sun drying, roasting, baking, steaming, boiling, grilling, and frying.

The dried plant is covered by at least one outer coating selected from the group consisting of having an outer layer of casing selected from group consisting of intestine, and cellulose; and comprising at least one coating selected from group consisting of bread crumbs, beer batter, egg batter, cornmeal batter, milk batter, yogurt batter, tea batter, coffee batter, malt batter, chocolate batter, honey batter, syrup batter, caramel batter, butterscotch batter, peanut butter batter, butter batter, margarine batter, cheese batter, cereal grain batter, nut batter, seed batter, bean batter, vegetable batter, plant batter, herb batter, fruit batter, wine batter, liquor batter, alcoholic batter, soft drink batter, soup batter, plant wax, animal wax, beeswax, carnauba wax, donut, roll, pie, pastry, waffle, crepe, pancake, pita, tortilla, bread, taco, biscuit, cookie, cake, jelly, royal jelly, cheese, cream cheese, cottage cheese, mozzarella, mascarpone, ricotta, butter, margarine, pudding, custard, candy, ice cream, gelato, sherbet, yogurt, chocolate, fudge, and at least one plant ingredient.

The dried plant is used as snack food.

The fruit skin and vegetable skin are created by peeling outer layer of at least one plant ingredient.

At least one plant ingredient is selected from the group consisting of fruit flavor, plant flavor, plant oil flavor, herb flavor, tea flavor, root flavor, flower flavor, flower bud flavor, pollen flavor, leaf flavor, stem flavor, stem shoot flavor, bulb flavor, nut flavor, seed flavor, bean flavor, cereal grain flavor, fruit skin flavor, vegetable skin flavor, vegetable flavor, vegetable oil flavor, and vegetable fat flavor, including hop, menthol, cordyceps, echinacea, elder, horehound, mallow, sage, thyme, cowslip, burnet, yarrow, marsh mallow, lady's mantle, speedwell, plantain, linden flower, wild thyme, hyssop, eucalyptus, sea buckthorn, elder blossom, verbena, lemon balm, clove, coriander, cumin, basil, dill, rosemary, parsley, fennel, oregano, allspice, catnip, wormwood, musk, chili, horseradish, turmeric, mustard, curry, wasabi, mountain mint, peppermint, spearmint, wintergreen, cinnamon, licorice, rose, jasmine, chamomile, chrysanthemum, lavender, acacia, safflower, vanilla, asafoetida, balsam, bay, buchu, birch, camphor, cannabis, caraway, calamus, cistus, citronella, clary sage, costus, cubeb, cypress, cypriol, davana, elecampane, fenugreek, fir, frankincense, galbanum, geranium, goldenrod, henna, helichrysum, hickory, juniper, ledum, litsea cubeba, marjoram, melaleuca, mountain savory, mugwort, myrrh, myrtle, neroli, nutmeg, orris, palo santo, petitgrain, pine, ravensara, red cedar, rosewood, sage, sassafras, schisandra, spikenard, spruce, tea tree, tsuga, valerian, yarrow, ylang ylang, zedoary, benzoin, copaiba, manuka, bergamot, patchouli, lilium, ambergris, gardenia, oakmoss, labdanum, coumarin, iris, water lily, ivy, amber, carnation, vetiver, cardamom, freesia, cyclamen, muguet, gardenia, tuberose, tonka bean, agarwood, cedarwood, sandalwood, alfafa, apple, orange, lemon, lime, grapefruit, grape, guava, plum, peach, pear, blackberry, blueberry, strawberry, cranberry, raspberry, cherry, mango, pineapple, pomegranate, papaya, watermelon, rockmelon, hamimelon, melon, honeydew, coconut, durian, passion fruit, banana, fig, apricot, mandarin, blackcurrant, starfruit, kiwi, pomelo, lychee, loquat, persimmon, tangerine, mangosteen, noni, sugar apple, mulberry, elderberry, gooseberry, lingonberry, juniper berry, jackfruit, dragonfruit, abiu, acai, acerola, ackee, cherry orange, moringa, ambarella, araza, arhat, atemoya, atherton raspberry, babaco, bacupari, bacuri, bael, barbadine, beach plum, batuan, bearberry, bignay, bilberry, bilimbi, biriba, black apple, black cherry, black raspberry, black mulberry, black sapote, blood orange, bolwarra, boquila, blue tongue, breadfruit, broad leaf bramble, buddha's hand, buffaloberry, brush cherry, burdekin plum, bush tomato, button mangosteen, caimito, calabash tree, calamondin, calamansi, camucamu, canary melon, canistel, cape gooseberry, capuli cherry, carambola, cardon, carob, cashew apple, cassabanana, cattley guava, cawesh, cedar bay cherry, ceriman, cereus peruvianus, charichuelo, chayote, che, chempedak, chenet, cherimoya, cherry ballart, chokeberry, chokecherry, chupa chupa, citron, clementine, cloudberry, cluster fig, cocky apple, coco plum, cocona, cocoplum, coffee cherry, common apple berry, conkerberry, cornelian cherry, crowberry, cupuacu, currant, curry leaf apple, custard apple, elephant apple, key apple, damson plum, date, date plum, davidson's plum, dead man's finger, desert banana, desert fig, desert lime, dodder laurel, doubah, double coconut, duku, eastern may hawthorn, emu apple, emu berry, false mastic, feijoa, fibrous satinash, finger lime, florida strangler fig, gac, galia melon, gambooge, genip, giant granadilla, otaheite gooseberry, goumi, governor's plum, montessa granadilla, yellow granadilla, greengage, grumichama, guanabana, guarana, cattley guava, pineapple guava, purple guava, strawberry guava, guavaberry, hackberry, hairless rambutan, hardy kiwi, hawthorn, hog plum, honeysuckle, horned melon, huckleberry, huito, ice cream bean, llama, Illawarra plum, imbe, jabuticaba, jambul, jatoba, jelly palm, jocote, jujube, kabosu, kaffir lime, kahikatea, kakadu lime, kakadu plum, kapok, karkalla, karonda, kei apple, kepel fruit, keule, key lime, kitembilla, korlan, kumquat, kutjera, kwai muk, lady apple, lakoocha, langsat, lanzone, lapsi, lardizabala, lemon aspen, leucaena, lillypilly, little gooseberry tree, limequat, loganberry, longan, lucuma, ma praang, mabolo, madrono, malabar plum, mamey sapote, mamoncillo, mangaba, manoao, maqui, marang, manila, mayapple, malay apple, mammee apple, maypop, medlar, melinjo, melon pear, midyim, miracle fruit, mock strawberry, purple mombin, red mombin, yellow mombin, monstera, mora de castilla, morinda, morinda citrifolia, mortiño, mountain pepper, mountain soursop, wild plum, mundu, muntries, muscadine, muskmelon, naartjie, nageia, nance, nannyberry, naranjilla, neem, nere, nonda plum, nungu, oil palm, oregan grape, oroblanco, otaheite gooseberry, palmyra palm, pawpaw, peachpalm, peanut butter fruit, pepino, pequi, peumo, phalsa, pigeon pea, pigeon plum, pigface, pindo palm, pineapple guava, pitomba, pois doux, pommecythere, pommerac, prickly pear, prune, pulasan, pummelo, pupunha, purple apple berry, purple granadilla, quandong, queensland ebony, quince, raisin tree, rambutan, red granadilla, red mulberry, rhubarb, riberry, rimu, rollinia, rose apple, rose hip, rose leaf bramble, rose myrtle, rowan, safou, sageretia, saguaro, salak, salal, salmonberry, sandpaper fig, santol, mamey, sapodilla, fibrous satinash, saskatoonberry, saw palmetto, sea buckthorn, serviceberry, shipova, small leaf tamarind, snow berry, soncoya, servicetree, soursop, southern crabapple, spanish lime, spanish tamarind, spiny monkey orange, star apple, carambola, strawberry guava, ugni, strawberry pear, surinam cherry, sweet apple berry, sweet ganadilla, sweet lemon, sweet orange, sweet pepper, sweetsop, sycamore fig, tamarillo, tamarind, monkey tamarind, velvet tamarind, tanjong, texas persimmon, thimbleberry, totara, toyon, wampee, water apple, wax apple, wax jambu, acerola, white aspen, white mulberry, white sapote, wild grape, wild orange, wild peach, wild plum, wild mangosteen, wineberry, wolfberry, wongi, wood apple, yangmei, yellow plum, yew, youngberry, zig zag vine, ahipa, arracacha, bamboo shoot, beetroot, burdock, broadleaf arrowhead, camas, canna, carrot, cassava, celeriac, chinese artichoke, daikon, earthnut pea, elephant foot yam, ensete, galangal, ginger, ginseng, hamberg parsley, lotus root, jerusalem artichoke, jicama, mashua, parsley root, parsnip, pignut, potato, prairie turnip, radish, rutabaga, salsify, scorzonera, skirret, swede, sweet potato, taro, ti, tigernut, turnip, ulluco, wasabi, water caltrop, water chestnut, yalcon, yam, avocado, bell pepper, bitter melon, bitter gourd, breadfruit, chayote, cucumber, ivy gourd, eggplant, aubergine, brinjal, luffa, nopal, okra, pepper, pumpkin, squash, sweet corn, sweet pepper, tinda, tomatillo, tomato, west indian gherkin, winter melon, zucchini, courgette, artichoke, broccoli, caper, cauliflower, courgette flower, globe artichoke, squash blossom, asparagus, prussian asparagus, bamboo shoot, celery, leek, wild leek, lemongrass, rhubarb, cardoon, kurrat, galangal, amaranth, arugula, beet green, bok choy, borage, broccoli rabe, brussel sprout, cabbage, catsear, celery, celtuce, chard, chaya, chickweed, chicory, chinese mallow, chive, choi sum, collard green, common purslane, corn salad, cress, dandelion, endive, fat hen, fiddlehead, fluted pumpkin, garden rocket, golden samphire, good king henry, greater plantain, kai lan, kale, komatsuna, kuka, lagos bologi, lamb's lettuce, lamb's quarters, land cress, leek, lettuce, lizards tail, malabar spinach, melokhia, miner's lettuce, mizuna green, mustard green, napa cabbage, new zealand spinach, orache, pak choy, paracress, pea, poke, radicchio, samphire, sculpit, stridolo, sea beet, sea kale, sierra leoni bologi, soko, sorrel, spinach, summer purslane, swiss chard, tatsoi, turnip green, watercress, water spinach, wheatgrass, winter purslane, yarrow, yao choy, cardoon, chive, florence fennel, elephant garlic, garlic, garlic chive, kohlrabi, onion, pearl onion, potato onion, spring onion, tree onion, welsh onion, quamash, scallion, shallot, rice, barley, oat, barley, rye, corn, wheat, buckwheat, millet, sorghum, spelt, quinoa, chicory, molasses, beet root, fonio, palmer's grass, teff, triticale, cattail, chia, flax, grain amaranth, canihua, pitseed goosefoot, wattleseed, almond, cashew, chestnut, coconut, hazelnut, macadamia, peanut, pecan, pine nut, pistachio, walnut, acorn, brazil nut, gingko nut, shea nut, beechnut, candlenut, kurrajong, mongongo, palm nut, karuka, red bopple nut, hickory, jacknut, pepea nut, yellow walnut, cycad, munya nut, monkey puzzle nut, paradise nut, colocynth, filbert, mamoncillo, maya nut, ogbono nut, water caltrop, juniper, podocarp, cempedak, coffee, egusi, fox nut, jackfruit, malabar gourd, nutmeg, breadnut, betel nut, cola nut, pili nut, olive, drumstick, okra, pumpkin seed, sesame seed, sunflower seed, lotus seed, hemp seed, green bean, red bean, azuki bean, black bean, back eyed bean, white bean, yellow bean, common bean, broad bean, pinto bean, soybean, lima bean, kidney bean, pea bean, potato bean, dolichos bean, moth bean, mung bean, ricebean, runner bean, tepary bean, urad bean, velvet bean, winged bean, yardlong bean, chickpea, pigeon pea, snap pea, snow pea, lentil, lupin, tarwi, carob, guar, horse gram, cocoa bean, coffee bean, bambara groundnut, cowpea, hyacinth bean, lablab, moringa oleifera, sterculia, yam bean, alfalfa, clover, mesquite, carob, tamarind, wisteria, aonori, arame, carola, caulerpa, dabberlocks, dulse, hijiki, kombu, laver, mozuku, nori, ogonori, sea grape, sea lettuce, sea weed, wakame, truffle, mushroom, bean sprout, acai, aloe vera, arnica, ashoka, asthma weed, astragalus, barberry, belladonna, bitter leaf, bitter orange, black cohosh, blessed thistle, cat's claw, cayenne, chaparral, chasteberry, cinchona, coffee senna, comfrey, digitalis, dong quai, ephedra, european mistletoe, evening primrose, fenugreek, feverfew, flaxseed, gingko, goldenseal, hoodia, horse chestnut, horsetail, jamaica dogwood, jojoba, kava, khat, konjac, kratom, kanna, licorice root, marigold, moringa oleifera, milk thistle, neem, opium poppy, purple coneflower, passion flower, red clover, syrian rue, st john's wort, saw palmetto, tea tree oil, thunder god vine, tulasi, turmeric, umckaloabo, valerian, white willow, yerba santa, ajwain, akudjura, alexanders, alkanet, alligator pepper, angelica, anise, anise hyssop, aniseed myrtle, annatto, apple mint, artemisia, asafoetida, asarabacca, avens, avocado leaf, barberry, bay leaf, bee balm, boldo, borage, black cardamom, blue fenugreek, caraway, cardamom, cassia, cayenne pepper, celery leaf, celery seed, chervil, chicory, cicely, cilantro, clary, costmary, cubeb pepper, cudweed, culantro, curry leaf, curry plant, dill seed, epazote, fenugreek, file powder, fingerroot, galangal, galingale, ganoderma, golpar, grains of paradise, grains of selim, houttuynia cordata, huacatay, indonesian bay leaf, jimbu, kaffir lime leaves, kala zeera, kawakawa seeds, kencur, keluak, kinh gioi, kokam seed, korarima, koseret leaves, lemon myrtle, lemon ironbark, lemon verbena, leptotes bicolor, lesser calamint, lime flower, lovage, mahlab, marjoram, mastic, mountain horopito, musk mallow, nasturtium, nigella, njangsa, neem, olida, orris root, pandan flower, pandan leaf, paprika, paracress, peppermint gum leaf, perilla, pandanus amaryllifolius, quassia, ramsons, rice paddy herb, rue, saffron, salad burnet, salep, sassafras, savory, silphium, shiso, sorrel, spikenard, star anise, sumac, sweet woodruff, tarragon, voatsiperifery, water-pepper, wattleseed, wild betel, willow herb, wood avens, and woodruff.

The plant powder, plant bag, and dried plant are packaged as individual package and multiple packages. The packaging can be in air tight container. And the packaging is selected from the group consisting of paper, plastic, metal, and glass.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. Plant powder, plant bag, and dried plant comprising:
at least one plant ingredient, with at least one flavoring;
wherein said at least one plant ingredient having nutrients including carbohydrates, vitamins, minerals, and antioxidants; and
wherein said at least one flavoring is selected from group consisting of bland, sweet, sour, bitter, salty, spicy, and pungent.

2. The plant powder, plant bag, and dried plant of claim 1 wherein said at least one plant ingredient is in form selected from group consisting of plant powder, plant bag, and dried plant.

3. The plant powder, plant bag, and dried plant of claim 1 wherein said at least one plant ingredient is selected from group consisting of herb, tea, root, flower, flower bud, pollen, stem, stem shoot, leaf, bulb, cereal grain, nut, seed, bean, fruit, fruit skin, vegetable, and vegetable skin.

4. The plant powder, plant bag, and dried plant of claim 1 wherein said at least one plant ingredient can further comprising addition of at least one nutritional ingredient selected from group consisting of vitamin, dietary mineral, amino acid, and fatty acid; said vitamin includes vitamin A, vitamin B1, vitamin B2, vitamin B3, vitamin B5, vitamin B6, vitamin B7, vitamin B9, vitamin B12, vitamin C, vitamin D, vitamin E, and vitamin K; said dietary mineral includes calcium, phosphorus, potassium, sulfur, sodium, chlorine, magnesium, iron, cobalt, copper, zinc, molybdenum, iodine, selenium, manganese, nickle, chromium, fluorine, boron, and strontium; said amino acid includes histidine, isoleucine, leucine, lysine, methionine, cysteine, phenylalanine, tyrosine, threonine, tryptophan, and valine; said fatty acid includes alpha-linoleic acid, and linoleic acid.

5. The plant powder, plant bag, and dried plant of claim 1 wherein said at least one plant ingredient can further comprising addition of at least one food additive selected from group consisting of acid, acidity regulator, alcohol, anticaking agent, antifoaming agent, antioxidant, bulking agent, coagulation agent, food coloring, color retention agent, emulsifier, flavor enhancer, flour treatment agent, gelling agent, glazing agent, humectant, leavening agent, tracer gas, preservative, stabilizer, sweetener, tenderizer, and thickener.

6. The plant powder, plant bag, and dried plant of claim 2 wherein said plant powder is created by grinding of said at least one plant ingredient into small particles.

7. The plant powder, plant bag, and dried plant of claim 6 wherein said plant powder can be brewed in boiling water for about 5 to 30 minutes before consumption of resulting plant drink, which can be cooled with refrigeration.

8. The plant powder, plant bag, and dried plant of claim 2 wherein said plant powder is created by method of boiling of said at least one plant ingredient into plant drink; and by method selected from group consisting of drying of said plant drink into soluble powder, freeze drying of said plant drink into granules, and spray drying of said plant drink into granules.

9. The plant powder, plant bag, and dried plant of claim 8 wherein said plant powder can be dissolved in hot water for consumption of resulting plant drink, which can be cooled with refrigeration.

10. The plant powder, plant bag, and dried plant of claim 2 wherein said plant powder is used as seasoning powder.

11. The plant powder, plant bag, and dried plant of claim 2 wherein said plant powder can be enclosed in small bottle of sprinkler having small openings at top of sprinkler for convenience and ease of use seasoning food in suitable amounts.

12. The plant powder, plant bag, and dried plant of claim 2 wherein said plant bag is created as porous bag containing said plant powder; and said porous bag having material selected from group consisting of paper, cloth, rubber, and bio-plastic.

13. The plant powder, plant bag, and dried plant of claim 2 wherein said plant bag can be brewed in boiling water for about 5 to 30 minutes before consumption of resulting plant drink, which can be cooled with refrigeration.

14. The plant powder, plant bag, and dried plant of claim 2 wherein said dried plant is created by method selected from group consisting of cut into thin slices, cut into small pieces, grind into small particles, and grind into powder; and by method selected from group consisting of sun drying, drying by heat, deep frying, baking, steaming, boiling, roasting, grilling, and frying.

15. The plant powder, plant bag, and dried plant of claim 2 wherein said dried plant comprising addition of at least one flavoring ingredient selected from group consisting of salt, vinegar, sugar, honey, syrup, ginger, garlic, chocolate, coffee, tea, caramel, butterscotch, peanut butter, butter, margarine, cheese, cream cheese, cottage cheese, mozzarella, mascarpone, ricotta, cream, sour cream, milk, ice cream, yogurt, gelato, sherbet, vegetable shortening, fish oil, fish liver oil, plant wax, animal wax, beeswax, carnauba wax, royal jelly, glycerol, egg, seafood, meat, soup stock, lactase, yeast, propolis, quinine, malt, and said at least one plant ingredient; said at least one flavoring ingredient is in form selected from group consisting of skin, skinned, unskinned, unshelled, cut, uncut, extract, juice, sauce, liquid, oil, gel, jelly, wax, cream, paste, powder, thin layer, small particles, and small pieces; and said at least one flavoring ingredient can be uncooked, and cooked by method selected from group consisting of deep frying, sun drying, roasting, baking, steaming, boiling, grilling, and frying.

16. The plant powder, plant bag, and dried plant of claim 2 wherein said dried plant is covered by at least one outer coating selected from group consisting of having an outer layer of casing selected from group consisting of intestine, and cellulose; and comprising at least one coating selected from group consisting of bread crumbs, beer batter, egg batter, cornmeal batter, milk batter, yogurt batter, tea batter, coffee batter, malt batter, chocolate batter, honey batter, syrup batter, caramel batter, butterscotch batter, peanut butter batter, butter batter, margarine batter, cheese batter, cereal grain batter, nut batter, seed batter, bean batter, vegetable batter, plant batter, herb batter, fruit batter, wine batter, liquor batter, alcoholic batter, soft drink batter, soup batter, plant wax, animal wax, beeswax, carnauba wax, donut, roll, pie, pastry, waffle, crepe, pancake, pita, tortilla, bread, taco, biscuit, cookie, cake, jelly, royal jelly, cheese, cream cheese, cottage cheese, mozzarella, mascarpone, ricotta, butter, margarine, pudding, custard, candy, ice cream, gelato, sherbet, yogurt, chocolate, fudge, and said at least one plant ingredient.

17. The plant powder, plant bag, and dried plant of claim 2 wherein said dried plant is used as snack food.

18. The plant powder, plant bag, and dried plant of claim 3 wherein said fruit skin and said vegetable skin are created by peeling outer layer of said at least one plant ingredient.

19. The plant powder, plant bag, and dried plant of claim 1 wherein said at least one plant ingredient is selected from group consisting of fruit flavor, plant flavor, plant oil flavor, herb flavor, tea flavor, root flavor, flower flavor, flower bud flavor, pollen flavor, leaf flavor, stem flavor, stem shoot flavor, bulb flavor, nut flavor, seed flavor, bean flavor, cereal grain flavor, fruit skin flavor, vegetable skin flavor, vegetable flavor, vegetable oil flavor, and vegetable fat flavor, including hop, menthol, cordyceps, echinacea, elder, horehound, mallow, sage, thyme, cowslip, burnet, yarrow, marsh mallow, lady's mantle, speedwell, plantain, linden flower, wild thyme, hyssop, eucalyptus, sea buckthorn, elder blossom, verbena, lemon balm, clove, coriander, cumin, basil, dill, rosemary, parsley, fennel, oregano, allspice, catnip, wormwood, musk, chili, horseradish, turmeric, mustard, curry, wasabi, mountain mint, peppermint, spearmint, wintergreen, cinnamon, licorice, rose, jasmine, chamomile, chrysanthemum, lavender, acacia, safflower, vanilla, asafoetida, balsam, bay, buchu, birch, camphor, cannabis, caraway, calamus, cistus, citronella, clary sage, costus, cubeb, cypress, cypriol, davana, elecampane, fenugreek, fir, frankincense, galbanum, geranium, goldenrod, henna, helichrysum, hickory, juniper, ledum, litsea cubeba, marjoram, melaleuca, mountain savory, mugwort, myrrh, myrtle, neroli, nutmeg, orris, palo santo, petitgrain, pine, ravensara, red cedar, rosewood, sage, sassafras, schisandra, spikenard, spruce, tea tree, tsuga, valerian, yarrow, ylang ylang, zedoary, benzoin, copaiba, manuka, bergamot, patchouli, lilium, ambergris, gardenia, oakmoss, labdanum, coumarin, iris, water lily, ivy, amber, carnation, vetiver, cardamom, freesia, cyclamen, muguet, gardenia, tuberose, tonka bean, agarwood, cedarwood, sandalwood, alfafa, apple, orange, lemon, lime, grapefruit, grape, guava, plum, peach, pear, blackberry, blueberry, strawberry, cranberry, raspberry, cherry, mango, pineapple, pomegranate, papaya, watermelon, rockmelon, hamimelon, melon, honeydew, coconut, durian, passion fruit, banana, fig, apricot, mandarin, blackcurrant, starfruit, kiwi, pomelo, lychee, loquat, persimmon, tangerine, mangosteen, noni, sugar apple, mulberry, elderberry, gooseberry, lingonberry, juniper berry, jackfruit, dragonfruit, abiu, acai, acerola, ackee, cherry orange, moringa, ambarella, araza, arhat, atemoya, atherton raspberry, babaco, bacupari, bacuri, bael, barbadine, beach plum, batuan, bearberry, bignay, bilberry, bilimbi, biriba, black apple, black cherry, black raspberry, black mulberry, black sapote, blood orange, bolwarra, boquila, blue tongue, breadfruit, broad leaf bramble, buddha's hand, buffaloberry, brush cherry, burdekin plum, bush tomato, button mangosteen, caimito, calabash tree, calamondin, calamansi, camucamu, canary melon, canistel, cape gooseberry, capuli cherry, carambola, cardon, carob, cashew apple, cassabanana, cattley guava, cawesh, cedar bay cherry, ceriman, cereus peruvianus, charichuelo, chayote, che, chempedak, chenet, cherimoya, cherry ballart, chokeberry, chokecherry, chupa chupa, citron, clementine, cloudberry, cluster fig, cocky apple, coco plum, cocona, cocoplum, coffee cherry, common apple berry, conkerberry, cornelian cherry, crowberry, cupuacu, currant, curry leaf apple, custard apple, elephant apple, key apple, damson plum, date, date plum, davidson's plum, dead man's finger, desert banana, desert fig, desert lime, dodder laurel, doubah, double coconut, duku, eastern may hawthorn, emu apple, emu berry, false mastic, feijoa, fibrous satinash, finger lime, florida strangler fig, gac, galia melon, gambooge, genip, giant granadilla, otaheite gooseberry, goumi, governor's plum, montessa granadilla, yellow granadilla, greengage, grumichama, guanabana, guarana, cattley guava, pineapple guava, purple guava, strawberry guava, guavaberry, hackberry, hairless rambutan, hardy kiwi, hawthorn, hog plum, honeysuckle, horned melon, huckleberry, huito, ice cream bean, llama, Illawarra plum, imbe, jabuticaba, jambul, jatoba, jelly palm, jocote, jujube, kabosu, kaffir lime, kahikatea, kakadu lime, kakadu plum, kapok, karkalla, karonda, kei apple, kepel fruit, keule, key lime, kitembilla, korlan, kumquat, kutjera, kwai muk, lady apple, lakoocha, langsat, lanzone, lapsi, lardizabala, lemon aspen, leucaena, lillypilly, little gooseberry tree, limequat, loganberry, longan, lucuma, ma praang, mabolo, madrono, malabar plum, mamey sapote, mamoncillo, mangaba, manoao, maqui, marang, manila, mayapple, malay apple, mammee apple, maypop, medlar, melinjo, melon pear, midyim, miracle fruit, mock strawberry, purple mombin, red mombin, yellow mombin, monstera, mora de castilla, morinda, morinda citrifolia, mortiño, mountain pepper, mountain soursop, wild plum, mundu, muntries, muscadine, muskmelon, naartjie, nageia, nance, nannyberry, naranjilla, neem, nere, nonda plum, nungu, oil palm, oregan grape, oroblanco, otaheite gooseberry, palmyra palm, pawpaw, peachpalm, peanut butter fruit, pepino, pequi, peumo, phalsa, pigeon pea, pigeon plum, pigface, pindo palm, pineapple guava, pitomba, pois doux, pommecythere, pommerac, prickly pear, prune, pulasan, pummelo, pupunha, purple apple berry, purple granadilla, quandong, queensland ebony, quince, raisin tree, rambutan, red granadilla, red mulberry, rhubarb, riberry, rimu, rollinia, rose apple, rose hip, rose leaf bramble, rose myrtle, rowan, safou, sageretia, saguaro, salak, salal, salmonberry, sandpaper fig, santol, mamey, sapodilla, fibrous satinash, saskatoonberry, saw palmetto, sea buckthorn, serviceberry, shipova, small leaf tamarind, snow berry, soncoya, servicetree, soursop, southern crabapple, spanish lime, spanish tamarind, spiny monkey orange, star apple, carambola, strawberry guava, ugni, strawberry pear, surinam cherry, sweet apple berry, sweet ganadilla, sweet lemon, sweet orange, sweet pepper, sweetsop, sycamore fig, tamarillo, tamarind, monkey tamarind, velvet tamarind, tanjong, texas persimmon, thimbleberry, totara, toyon, wampee, water apple, wax apple, wax jambu, acerola, white aspen, white mulberry, white sapote, wild grape, wild orange, wild peach, wild plum, wild mangosteen, wineberry, wolfberry, wongi, wood apple, yangmei, yellow plum, yew, youngberry, zig zag vine, ahipa, arracacha, bamboo shoot, beetroot, burdock, broadleaf arrowhead, camas, canna, carrot, cassava, celeriac, chinese artichoke, daikon, earthnut pea, elephant foot yam, ensete, galangal, ginger, ginseng, hamberg parsley, lotus root, jerusalem artichoke, jicama, mashua, parsley root, parsnip, pignut, potato, prairie turnip, radish, rutabaga, salsify, scorzonera, skirret, swede, sweet potato, taro, ti, tigernut, turnip, ulluco, wasabi, water caltrop, water chestnut, yalcon, yam, avocado, bell pepper, bitter melon, bitter gourd, breadfruit, chayote, cucumber, ivy gourd, eggplant, aubergine, brinjal, luffa, nopal, okra, pepper, pumpkin, squash, sweet corn, sweet pepper, tinda, tomatillo, tomato, west indian gherkin, winter melon, zucchini, courgette, artichoke, broccoli, caper, cauliflower, courgette flower, globe artichoke, squash blossom, asparagus, prussian asparagus, bamboo shoot, celery, leek, wild leek, lemongrass, rhubarb, cardoon, kurrat, galangal, amaranth, arugula, beet green, bok choy, borage, broccoli rabe, brussel sprout, cabbage, catsear, celery, celtuce, chard, chaya, chickweed, chicory, chinese mallow, chive, choi sum, collard green, common purslane, corn salad, cress, dandelion, endive, fat hen, fiddlehead, fluted pumpkin, garden rocket, golden samphire, good king henry, greater plantain, kai lan, kale, komatsuna, kuka, lagos bologi, lamb's lettuce, lamb's quarters, land cress, leek, lettuce, lizard's tail, malabar spinach, melokhia, miner's lettuce, mizuna green, mustard green, napa cabbage, new zealand spinach, orache, pak choy, paracress, pea, poke, radicchio, samphire, sculpit, stridolo, sea beet, sea kale, sierra leoni bologi, soko, sorrel, spinach, summer purslane, swiss chard, tatsoi, turnip green, watercress, water spinach, wheatgrass, winter purslane, yarrow, yao choy, cardoon, chive, florence fennel, elephant garlic, garlic, garlic chive, kohlrabi, onion, pearl onion, potato onion, spring onion, tree onion, welsh onion, quamash, scallion, shallot, rice, barley, oat, barley, rye, corn, wheat, buckwheat, millet, sorghum, spelt, quinoa, chicory, molasses, beet root, fonio, palmer's grass, teff, triticale, cattail, chia, flax, grain amaranth, canihua, pitseed goosefoot, wattleseed, almond, cashew, chestnut, coconut, hazelnut, macadamia, peanut, pecan, pine nut, pistachio, walnut, acorn, brazil nut, gingko nut, shea nut, beechnut, candlenut, kurrajong, mongongo, palm nut, karuka, red bopple nut, hickory, jacknut, pepea nut, yellow walnut, cycad, munya nut, monkey puzzle nut, paradise nut, colocynth, filbert, mamoncillo, maya nut, ogbono nut, water caltrop, juniper, podocarp, cempedak, coffee, egusi, fox nut, jackfruit, malabar gourd, nutmeg, breadnut, betel nut, cola nut, pili nut, olive, drumstick, okra, pumpkin seed, sesame seed, sunflower seed, lotus seed, hemp seed, green bean, red bean, azuki bean, black bean, back eyed bean, white bean, yellow bean, common bean, broad bean, pinto bean, soybean, lima bean, kidney bean, pea bean, potato bean, dolichos bean, moth bean, mung bean, ricebean, runner bean, tepary bean, urad bean, velvet bean, winged bean, yardlong bean, chickpea, pigeon pea, snap pea, snow pea, lentil, lupin, tarwi, carob, guar, horse gram, cocoa bean, coffee bean, bambara groundnut, cowpea, hyacinth bean, lablab, moringa oleifera, sterculia, yam bean, alfalfa, clover, mesquite, carob, tamarind, wisteria, aonori, arame, carola, caulerpa, dabberlocks, dulse, hijiki, kombu, laver, mozuku, nori, ogonori, sea grape, sea lettuce, sea weed, wakame, truffle, mushroom, bean sprout, acai, aloe vera, arnica, ashoka, asthma weed, astragalus, barberry, belladonna, bitter leaf, bitter orange, black cohosh, blessed thistle, cat's claw, cayenne, chaparral, chasteberry, cinchona, coffee senna, comfrey, digitalis, dong quai, ephedra, european mistletoe, evening primrose, fenugreek, feverfew, flaxseed, gingko, goldenseal, hoodia, horse chestnut, horsetail, jamaica dogwood, jojoba, kava, khat, konjac, kratom, kanna, licorice root, marigold, moringa oleifera, milk thistle, neem, opium poppy, purple coneflower, passion flower, red clover, syrian rue, st john's wort, saw palmetto, tea tree oil, thunder god vine, tulasi, turmeric, umckaloabo, valerian, white willow, yerba santa, ajwain, akudjura, alexanders, alkanet, alligator pepper, angelica, anise, anise hyssop, aniseed myrtle, annatto, apple mint, artemisia, asafoetida, asarabacca, avens, avocado leaf, barberry, bay leaf, bee balm, boldo, borage, black cardamom, blue fenugreek, caraway, cardamom, cassia, cayenne pepper, celery leaf, celery seed, chervil, chicory, cicely, cilantro, clary, costmary, cubeb pepper, cudweed, culantro, curry leaf, curry plant, dill seed, epazote, fenugreek, file powder, fingerroot, galangal, galingale, ganoderma, golpar, grains of paradise, grains of selim, houttuynia cordata, huacatay, indonesian bay leaf, jimbu, kaffir lime leaves, kala zeera, kawakawa seeds, kencur, keluak, kinh gioi, kokam seed, korarima, koseret leaves, lemon myrtle, lemon ironbark, lemon verbena, leptotes bicolor, lesser calamint, lime flower, lovage, mahlab, marjoram, mastic, mountain horopito, musk mallow, nasturtium, nigella, njangsa, neem, olida, orris root, pandan flower, pandan leaf, paprika, paracress, peppermint gum leaf, perilla, pandanus amaryllifolius, quassia, ramsons, rice paddy herb, rue, saffron, salad burnet, salep, sassafras, savory, silphium, shiso, sorrel, spikenard, star anise, sumac, sweet woodruff, tarragon, voatsiperifery, water-pepper, wattleseed, wild betel, willow herb, wood avens, and woodruff.

20. The plant powder, plant bag, and dried plant of claim 1 having packaging as individual package and multiple package; said packaging is in air tight container; and said packaging is selected from group consisting of paper, plastic, metal, and glass.
